(19) United States
(12) Patent Application Publication
(10) Pub. No.: US 2026/0175590 A1
(43) Pub. Date: Jun. 25, 2026

(54) Printing Apparatus and Additive Manufacturing Method Comprising Automatic Position Calibration

(71) Applicant: DiHeSys Digital Health Systems GmbH, Schwäbisch-Gmünd (DE)

(72) Inventors: Markus Dachtler, Ulm (DE); Gerald Huber, Plüderhausen (DE); Alexander Richter, Schwäbisch Gmünd (DE); Benjamin Huber, Plüderhausen (DE)

(21) Appl. No.: 18/713,497

(22) PCT Filed: Nov. 24, 2022
(86) PCT No.: PCT/EP2022/083212

§ 371 Date: May 24, 2024

(30) Foreign Application Priority Data
Nov. 24, 2021 (DE) 202021003596.6

(51) Int. Cl. B41J 2/21; B41J 11/00

(52) U.S. Cl. CPC B41J 2/2132; B41J 11/008

(57) ABSTRACT

A printing apparatus and method for additive manufacturing processes comprising an optical device configured to optically detect a printing nozzle from below and record an image of the printing nozzle to enable automatic position calibration of the printing nozzle.

### FIELD OF THE INVENTION

The present invention relates to a printing apparatus for additive manufacturing processes comprising an optical device for recording an optical reproduction of the printing nozzle(s) of the printing apparatus to enable automatic position calibration of the printing nozzle(s). A further object of the invention is a method comprising automatic position calibration of the printing nozzle(s) for additive manufacturing of objects, preferably pharmaceutical dosage forms, using the apparatus according to the invention.

### BACKGROUND OF THE INVENTION

In additive manufacturing processes such as 2D and 3D printing, which generally involve computer-controlled positioning of the printing material on a printing table of the printing apparatus, there is generally the problem that the position of the printing head, or more precisely its output device, usually the printing nozzle, from which the printing material is applied to the printing table, deviates from the position of the printing table stored in the computer unit, at least in the x-y direction (i.e. in the horizontal plane), i.e. there is an offset between the position of the printing nozzle “imagined” by the printing system and the actual position (these positions stored in the computer unit, in particular the x-y position, but also the z position (.i.e. the position above the printing table) there is an offset between the position of the printing nozzle “imagined” by the printing system and the actual position (these positions stored in the computer unit, in particular the x-y position, but also the z position (i.e. the position above the printing table) are also referred to hereinafter as the “expected” or “theoretical” position, i.e. the x-y position or z position). To compensate for this offset, a position calibration of the printing nozzle must be carried out before the start of the printing process, with which the system is informed of the actual position of the printing nozzle relative to the printing surface, at least in x-y alignment, for any initial value. If there are several printing heads, the position calibration must of course be carried out individually for each printing nozzle. Furthermore, a printing apparatus with several printing heads has the additional problem that the printing heads are often also offset from each other. Ideally, the printing nozzles of the printing heads should have a defined, preferably identical distance to each other (according to CAD a distance of 8 cm), but deviations occur due to manufacturing tolerances, which result in an offset during the printing process (e.g. actual distance 8.05 cm instead of 8.00 cm). The offset per nozzle opening (hereinafter also referred to as “tool”) must therefore be defined relative to the printing surface. This is then continuously compensated for by the printing apparatus during the printing process so that the printing nozzle or nozzle opening of the different printing heads always reaches the same position when the tool is changed. Up to now, the above parameters such as positioning and offset have been calibrated manually.

The technical problem underlying the invention is to simplify 2D and 3D printing processes by providing systems that enable these calibrations to be automated.

### SUMMARY OF THE INVENTION

The above technical problem is solved by the subject matter of the present invention disclosed in the claims as well as in the present description and the accompanying drawings.

In particular, the present invention provides a printing apparatus for additive manufacturing processes, comprising
one or more printing heads, each comprising a printing nozzle, wherein, optionally, the printing head or printing heads are vertically movable, and
a printing bed comprising a printing table movable in horizontal direction and, optionally in vertical direction, comprising a printing surface,

wherein the printing table comprises an optical device configured to record an optical reproduction of the printing nozzle or printing nozzles at least from below.

In a preferred embodiment, the optical device is configured to record an optical reproduction of the printing nozzle or printing nozzles directly from below.

In another preferred embodiment of the invention, the optical device comprises at least one mirror configured to indirectly record the printing nozzle(s).

In a further embodiment, the optical device is further configured to record an optical reproduction of the printing nozzle or printing nozzles, respectively, from the side. In this embodiment, the optical device preferably comprises a mirror configured to record the printing nozzle(s) from the side. In a further development of this embodiment, the mirror is configured to record the printing nozzle(s) from the side in such a way that it is possible to generate a recording of the printing nozzle(s) from the side in a partial cutout of the recorded area of the printing nozzle(s) from below.

In preferred embodiments of the invention, the optical device is configured to record two or more, more preferably two, optical reproductions, preferably independently of one another, of the printing nozzle(s) from below and/or from the side, i.e. in the latter case from two sides, preferably from two opposite sides. The recording of the further, preferably the second, optical reproduction of the printing nozzle(s) from below can be carried out directly or indirectly via a further mirror, preferably independently of the arrangement for recording the first reproduction. For the independent recording of two optical reproductions of the printing nozzle(s) from the side, a further mirror is preferably provided, which is preferably configured in such a way that an optical reproduction of the printing nozzle(s) takes place from a side which is opposite the optical reproduction from the (first) side by the mirror configured to record the printing nozzle(s). In a corresponding further development of the printing apparatus having a mirror for recording the printing nozzle from the side, in the case of two mirrors (which are preferably arranged on opposite sides of the printing nozzle(s)), the mirrors for recording the printing nozzle(s) from the side can be designed in such a way that at least one optical reproduction or image respectively, preferably two optical reproductions or images respectively, of the printing nozzle(s) from the side can be produced in a partial section of the optical reproduction or image, respectively, of the printing head or printing heads from below.

According to the invention, it is also preferred that the optical device is arranged in a recording device separate from the printing surface.

Preferably, the optical device comprises or consists of a CCD camera. Preferably, the optical device comprises a CCD camera and a mirror configured to indirectly record the printing nozzle(s). In a further preferred embodiment, the optical device comprises a CCD camera and further comprises a mirror configured for recording the printing nozzle(s) from the side, wherein it is further preferred that the mirror is configured for recording the printing nozzle(s) from the side in such a way that in a partial section of the optical reproduction or image, respectively, of the printing nozzle(s) from below, an optical reproduction or image, respectively, of the printing nozzle(s) from the side can be produced. In further embodiments of the invention, the mirror for recording the printing nozzle(s) can be arranged in the CCD camera(s), i.e. integrated therein. In the above-mentioned embodiments for recording two or more, preferably two, reproductions of the printing nozzle(s) from below and/or from the side, the apparatus of the invention comprises one (or more) further CCD camera(s), optionally comprising a (further) mirror for recording the printing nozzle(s) from below and/or from the side. with a (further) mirror for recording the further reproduction of the printing nozzle(s) from below and/or a further mirror configured to record a (further) optical reproduction of the printing nozzle(s) from the side, the further mirror preferably being designed such that the further CCD camera records a reproduction of the printing nozzle(s) from the side which is opposite the side of the first reproduction recorded from the side. It is expressly noted that the further CCD camera (or a plurality thereof) need not necessarily be configured to record or capture, respectively, the printing nozzle(s) from below. In certain embodiments of the invention, the second (or at least one of the further) CCD camera(s) preferably serves to merely record one or more further reproduction(s) of the printing nozzle(s) from the side.

In further embodiments of the invention, a second optical device for recording or capturing, respectively, the printing nozzle(s) from the side is provided, wherein this second device is not necessarily located on/in the printing table but may be integrated in the printing apparatus in another manner. Thus, the second optical device can be arranged on the printing head or at least at its height, preferably in such a way that one or more further optical reproductions of the printing nozzle(s) is recorded from the side, this further side preferably being opposite the first side described above. Preferably, the second optical device comprises or consists of a (further) CCD camera.

In another embodiment of the invention, the printing apparatus comprises one or more proximity sensors, preferably one proximity sensor per printing head/printing nozzle, which is/are arranged and adapted in the printing apparatus such that the (respective) proximity sensor detects the (associated or assigned, respectively) printing nozzle, i.e. recognizes when the (associated or assigned, respectively) printing nozzle is at a respective predetermined distance of the printing nozzle from its associated or assigned, respectively, proximity sensor. The proximity sensor(s) is/are preferably selected from capacitive and inductive proximity sensors. Capacitive proximity sensors are particularly preferred. When the printing nozzle is detected, the proximity sensor preferably sends an electrical signal to a control unit. The proximity sensor(s) are preferably arranged on the printing bed or preferably on the printing table of the printing apparatus in such a way that the respective printing nozzle(s) is/are detected at a preselected distance of the (associated or assigned, respectively) printing nozzle from the (assigned or associated, respectively) proximity sensor. When the proximity sensor(s) is/are arranged on the printing bed of the printing apparatus, the printing nozzle(s) of the printing apparatus are movable at least in the height (in the z-direction according to the invention) above the printing bed and thus also in the height (in the z-direction) of the printing table. In another embodiment, instead of the proximity sensor or sensors being arranged on the printing table, the printing table is typically movable in the z-direction. The preselected distance of the respective printing nozzle from the proximity sensor, at which the latter detects the printing nozzle, is typically 0.5 mm to 5.0 mm, preferably 1.0 to 3.0 mm, more preferably 0.5 mm or 1.0 mm or 1.5 mm or 2.0 mm or 2.5 mm or 3.0 mm.

According to a further aspect, the present invention discloses a further printing apparatus for additive manufacturing processes, comprising
one or more printing heads, each comprising a printing nozzle, the printing heads or printing head possibly being vertically movable,
a printing bed comprising a printing table movable in the horizontal direction and possibly in the vertical direction, comprising a printing surface, and
one or more proximity sensors configured to detect the printing nozzle(s) at a predetermined distance of the respective printing nozzle from the proximity sensor assigned to this printing nozzle.

The above preferred embodiments of the arrangement and design of the proximity sensor or proximity sensors also apply to the further printing apparatus of the invention defined above.

Preferably, any of the printing apparatus disclosed herein comprises a computerized control device configured to move and detect the position of the printing table and/or at least the printing nozzle(s) of the printing head(s).

Further, any of the printing apparatus disclosed herein preferably comprises a computerized image processing device configured to display and process the image data of the printing nozzle(s) generated by the optical device.

It is also preferred that any of the printing apparatus disclosed herein comprises a computer unit configured to correlate the image data of the computerized image processing device and the position data of the computerized control device. In particular, the computer unit is configured to measure and store differences in position data at least in the x-y direction (i.e. horizontal position data), preferably also in the z direction (i.e. vertical position data).

In preferred embodiments of the invention, any of the printing apparatus disclosed herein comprises at least one device for analyzing the additive manufacturing process carried out using the printing apparatus, in particular 2D and/or 3D printing, and/or the object produced with the aid of the device.

Preferably, each of the printing apparatus disclosed herein comprises at least one device for spectroscopic measurement of material applied to the printing surface. In particularly preferred embodiments, this device is a device for infrared spectroscopic measurement, more preferably an NIR (near infrared) device. In other embodiments, a Raman spectroscopic device is used, whereby both Raman spectroscopy and infrared spectroscopy (more preferably NIR spectroscopy) can also be used simultaneously or sequentially, i.e. the apparatus according to the invention can comprise both a device for Raman spectroscopy and a device for infrared spectroscopy, more preferably for NIR spectroscopy.

In general, a further printing apparatus for additive manufacturing processes is also disclosed according to the invention, comprising
one or more printing heads, each comprising a printing nozzle, wherein the printing heads or printing head may be vertically movable, and
a printing bed comprising a printing table movable in the horizontal direction and, optionally, in the vertical direction, comprising a printing surface, and
at least one device for spectroscopic measurement of material applied to the printing surface.

Preferred embodiments of the spectroscopic measuring device are as already outlined above.

In a further embodiment of the invention, the printing heads(s) each comprises a device for measuring the flow rate of material flowing into and/or through the printing heads or through the printing nozzle, respectively. In preferred embodiments, the flow rate is measured by means of a magnetic-inductive flow measuring device. According to the invention, a device for flow measurement is preferably used in printing apparatus of the invention which are designed in particular for, or at least also for, 2D printing.

Furthermore, in a preferred embodiment of the invention, the printing head(s) can each comprise a device for measuring the number of droplets emerging from the printing nozzle(s), in particular the number of droplets emerging per unit of time. According to the invention, a device for droplet counting is preferably used in printing apparatus of the invention which are designed in particular for, or at least also for, 2D printing.

According to the invention, the flow rate and/or the number of droplets emerging from the printing nozzle(s) can be measured using the optical device(s) described above, preferably CCD camera(s) and mirror(s) for recording the optical reproduction of the printing nozzle(s) from the side, preferably from opposite sides. When using two optical devices or two CCD cameras, respectively, a three-dimensional reproduction of the printing nozzle(s) and/or the material emerging from it/these, which emerges in particular in the form of drops or droplets, can also preferably be obtained from the generated images.

In a further embodiment, any of the printing apparatus disclosed herein comprises a device, preferably an infrared camera, for recording a thermal image of material emerging from the printing nozzle(s) and/or material applied to the printing surface.

Further, any of the printing apparatus disclosed herein may be configured such that the printing heads(s) comprises a magnetic inductive mass flow meter or inductive mass pickup device, respectively.

In a further preferred embodiment, the printing table comprises a weighing device.

Preferably, any of the printing apparatus disclosed herein comprises a preferably computerized device for recording, handling and monitoring the process data collected by means of the above process analysis devices. More preferably, said unit referred to hereinbefore as a preferred computerized process monitoring device is connected to the aforementioned computerized control, image processing and computing units via data exchange and/or data transmission and/or data receiving means, so that of the process parameters obtained via the process monitoring device(s) can be integrated.

A further aspect of the present invention is a method for additive manufacturing of objects, preferably pharmaceutical dosage forms, using an apparatus according to the invention, comprising the steps of
positioning the printing table in an x-y position such that the x-y position of the theoretical (i.e. an expected) position of the printing nozzle corresponds to the x-y position of a reference point of the printing table and recording or capturing, respectively, of the or a printing nozzle by the optical device can be carried out at least from below;
recording an image of the printing nozzle;
determining the actual x-y position of the printing nozzle using the captured image;
positioning the printing table in the x-y plane so that the reference point of the printing table is in the actual x-y position of the printing nozzle above the reference point;
measuring the difference between the actual x-y position of the printing nozzle above the reference point of the printing table and the theoretical or expected. Respectively, x-y position of the printing nozzle above the reference point of the printing table;
recording, preferably storing, the difference;
recording a further image of the printing nozzle by the optical device to check the position of the actual position of the printing nozzle above the printing table; and
printing an object taking into account the measured or recorded difference between the actual x-y position of the printing nozzle above the reference point of the printing table and the expected x-y position of the printing nozzle above the reference point of the printing table.

In a further development of the method according to the invention, in step (b) the optical device according to the invention additionally captures or records, the printing nozzle from the side, preferably by using mirror optics as described above with respect to the printing apparatus according to the invention. In step (c), the image captured from the side enables the determination of the actual height of the printing nozzle above the printing table (actual value for z in the axis system according to FIG. 1) in comparison to the height expected by the printing system (theoretical z value) on the basis of the image of the printing nozzle from the side. Correspondingly, in the next step (step (e)), the difference between the actual height (actual z-value) of the printing nozzle above the printing table and the theoretical height (theoretical z-value) is measured, i.e. determined. Then, in step (f) of the above method, the difference between the actual height (actual z-value) and an expected height, typically the (theoretical) height expected by the system (theoretical/expected z-value), is recorded, preferably stored. By capturing a further image of the printing nozzle from the side using the optical device, the position of the printing nozzle with regard to its height (z value) above the printing table is also checked in step (g) in this further development of the printing process. Finally, in step (h), the object is printed by additionally taking into account the (measured and recorded, respectively) difference between the actual z-position of the printing nozzle above the printing table and the theoretical z-position of the printing nozzle above the printing table.

In another embodiment of the calibration method defined above, the position calibration with respect to the height of the printing nozzle(s) above the printing table (z-position) is carried out using the one or more proximity sensors as described above, preferably one proximity sensor per printing nozzle/printing head. The height of the printing nozzle(s) above the printing table (i.e. in the z-direction; see FIG. 1) is determined by detecting the height using the one or more proximity sensors as defined above, preferably one proximity sensor per printing nozzle or printing head. In one embodiment, the printing head(s) is/are movable in a vertical direction and the proximity sensor is preferably arranged on the printing bed in such a way that no movement of the printing head(s) is required to move it/them to the selected detection distance. In another embodiment, instead of the printing head(s) (or in addition thereto), the proximity sensor(s) can be arranged on the printing bed so as to be movable at least in the z-direction, i.e. vertically, in order to move it/them to the detection distance for the respective printing nozzle(s). In any case, the height of the proximity sensor(s) above the printing bed (more precisely its surface) is known and preferably stored in a corresponding storage medium of a control system, preferably a computer unit.

By moving the respective printing head and/or the proximity sensor assigned to the printing nozzle/printing head at its detection distance, the actual height of the printing nozzle above the printing table (actual value for z in the axis system according to FIG. 1) is determined in this embodiment in comparison to an expected height (theoretical z value) typically expected by the printing system. Accordingly, in a next step, preferably (step (e)), the difference between the actual height (actual z-value) of the printing nozzle above the printing table and the theoretical height (theoretical z-value) is measured, i.e. determined. Then, in a next step, preferably step (f) of the above method, the difference between the actual height (actual z-value) and the (theoretical) height (theoretical/expected z-value) expected by the system is recorded, preferably stored. By further moving the respective printing head and/or the proximity sensor assigned to the printing nozzle/printing head at its detection distance, the position of the printing nozzle with regard to its height (z value) above the printing table is also checked in step (g) in the present further development of the printing method. Finally, in step (h), the object is printed with additionally taking into account the difference between the actual z-position of the printing nozzle above the printing table and the theoretical z-position of the printing nozzle above the printing table.

In a further aspect, the present invention provides a further method for the additive manufacturing of objects, preferably pharmaceutical dosage forms, using the further printing apparatus defined above, comprising the steps of
determining the actual z-position of the printing nozzle(s) above the printing table using one or more proximity sensors, wherein, optionally, each proximity sensor is assigned to one printing nozzle;
measuring the difference between the actual z-position of the printing nozzle(s) above the printing table and a theoretical (i.e. expected) z-position of the printing nozzle above the printing table;
recording, preferably storing, the difference;
re-determining the actual z-position of the printing nozzle(s) above the printing table using one or more proximity sensors to check the position of the actual position of the printing nozzle above the printing table, wherein, optionally, each proximity sensor is assigned to one printing nozzle;
printing an object taking into account the measured difference between the actual z-position of the printing nozzle(s) above the printing table and the theoretical or expected z-position of the printing nozzle above the printing table.

In certain embodiments of this further additive manufacturing process, step (D) may be provided as an optional step.

The actual z-position of the printing nozzle(s) above the printing table can be determined as described above with respect to the first additive manufacturing process.

In one embodiment of additive manufacturing processes according to the invention, using 3 or more proximity sensors, preferably 3 or 4 or 5 proximity sensors, correspondingly using 3 or more printing heads/printing nozzles, preferably 3 or 4 or 5 printing heads/printing nozzles, the proximity sensors being arranged on the printing table, it is also possible to determine whether the printing table forms a horizontally uniform, in particular horizontal plane relative to the printing heads/printing nozzles by determining the respective z-position of the printing nozzles. This is preferably used to ensure even printing of the object to be created in a horizontal direction, in particular a uniform layer structure of the printed material, e.g. in the case of FFM or FDM printing processes.

Typically, and preferably according to the invention, the methods according to the invention are carried out in a computer or computer-assisted manner, particularly preferably using the computer-assisted control and/or image processing and/or computer unit already mentioned above.

Further, the methods according to the invention are preferably carried out using one or more of the above-mentioned devices for analyzing the respective manufacturing process.

### BRIEF DESCRIPTION OF THE DRAWINGS

The present invention is illustrated in more detail below with reference to the accompanying drawings:

FIG. 1 shows a schematic representation of the general structure of a printing apparatus, in the example having two printing heads (tools) (1, 2), a printing table with the printing surface (3) and an area (4) which, according to the invention, accommodates an optical device for recording or capturing, respectively, the printing heads (individually or, in other embodiments, also together) (referred to herein as the service bay). Also shown is the absolute zero point of the configuration with spatial axes x, y and z (5). The printing table is movable at least in the x-and y-axis (i.e. horizontally) by means of corresponding electro-mechanical devices but may also be movable vertically (i.e. z-axis) together with the printing bed in certain embodiments. In other embodiments, the printing head(s) may be movable vertically.

FIG. 2 shows a schematic representation of an optical device for use in the invention, comprising a camera (6), preferably a CCD camera, and a first mirror XY (7), by means of which the camera can detect the position of a printing head or the position of the printing nozzles of a printing head, respectively, of a printing apparatus according to the invention in the XY plane, i.e. usually horizontally, and a second mirror Z (8), by means of which the camera can detect the position of a printing head or the position of the printing nozzles of a printing head, respectively, of a printing apparatus according to the invention in the Z direction, i.e. usually vertically, can be detected, wherein the first and the second mirror are arranged in such a way that the vertical position of the printing head or the printing nozzle, respectively, is displayed in a section of the image of the position of the printing head or the printing nozzle, respectively, in the horizontal plane.

FIG. 3A shows an exemplary photographic image of a printing nozzle of a printing apparatus according to the invention having an optical device which shows the position of the printing nozzle in the horizontal plane (X-Y plane) before calibration, in which the printing nozzle is not yet precisely aligned (the opening of the printing nozzle is not arranged concentrically around the crosshair point, which is used here merely for illustration purposes).

FIG. 3B shows an exemplary photographic image of a printing nozzle of a printing apparatus according to the invention having an optical device which shows the position of the printing nozzle in the horizontal plane (X-Y plane) after calibration, in which the printing nozzle is precisely aligned (the opening of the printing nozzle is arranged concentrically around the crosshair point, which is used here merely for illustrative purposes).

FIG. 4 shows an exemplary representation of an image of a printing nozzle of a printing apparatus according to the invention, which would result from an optical device of the invention shown schematically in FIG. 1, whereby the image of the printing nozzle in the X-Y direction can be seen in the upper section of FIG. 4 (via the mirror XY), while the image of the printing nozzle in the Z direction (via the mirror Z) can be seen in the lower section of FIG. 4.

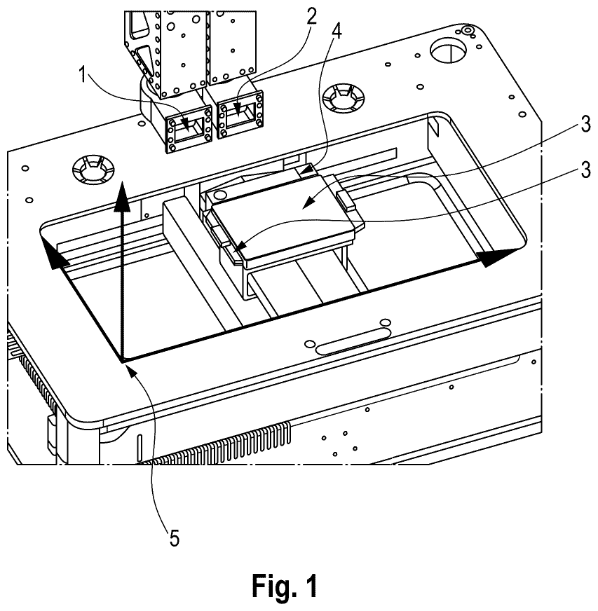

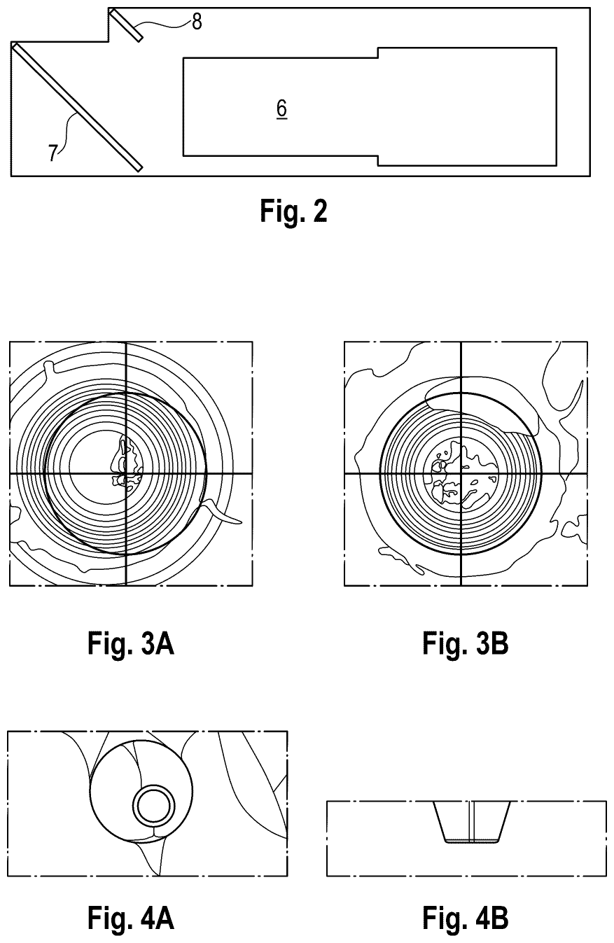

### DETAILED DESCRIPTION OF THE INVENTION

In particular, the present invention provides the following embodiments:
1. A printing apparatus for additive manufacturing processes, comprising
   one or more printing heads, each comprising a printing nozzle, wherein, optionally, the printing head or printing heads are vertically movable, and
      a printing bed comprising a printing table movable in the horizontal direction and possibly in the vertical direction, comprising a printing surface,
wherein the printing table comprises an optical device configured to recording an optical reproduction of the printing nozzle or printing nozzles at least from below.
2. The printing apparatus according to embodiment 1, wherein the optical device records the printing nozzle(s) directly from below.
3. The printing apparatus according to embodiment 1, wherein the optical device comprises at least one mirror configured to indirectly recording the printing nozzle(s).
4. The printing apparatus according to any one of the preceding embodiments, wherein the optical device is further configured to record the printing nozzle or printing nozzles from the side.
5. The printing apparatus according to embodiment 4, wherein the optical device is configured to record the printing nozzle or printing nozzles from two sides, preferably opposite sides.
6. The printing apparatus according to embodiment 4, wherein the optical device comprises a mirror configured to record the printing nozzle(s) from the side.
7. The printing apparatus according to embodiment 5, wherein the optical device comprises two mirrors configured to record the printing nozzle(s) from two sides, preferably opposite sides.
8. The printing apparatus according to embodiment 6 or 7, wherein the mirror or mirrors for recording the printing nozzle or nozzles from the side is/are configured in a manner that at least one recording of the printing nozzle or nozzles from the side can be generated in a partial section of the recording of the printing head or printing heads from below.
9. The printing apparatus according to one of the preceding embodiments, wherein the optical device is arranged in a recording device separate from the printing surface.
10. The printing apparatus according to any one of the preceding embodiments, wherein the optical device comprises one or more CCD cameras.
11. The printing apparatus according to one of the preceding embodiments, comprising one or more proximity sensors, preferably one proximity sensor per printing head/printing nozzle, which is/are arranged and configured in the printing apparatus in a manner such that the respective proximity sensor detects the printing nozzle assigned thereto when the assigned printing nozzle has a respective predetermined distance from the respective proximity sensor.
12. The printing apparatus according to embodiment 11, wherein the proximity sensor(s) is/are selected from inductive and capacitive proximity sensors, preferably capacitive proximity sensors.
13. The printing apparatus according to any one of the preceding embodiments, comprising a computerized control device configured to move and detect the position of the printing table and/or at least the printing nozzle(s) of the printing head(s).
14. The printing apparatus according to any one of the preceding embodiments, comprising a computerized image processing device configured to display and process the image data of the printing nozzle(s) generated by the optical device.
15. The printing apparatus according to embodiments 13 and 14, wherein printing apparatus comprises a computer unit configured to correlate the image data of said computerized image processing device and the position data of said computerized control device.
16. The printing apparatus according to any one of the preceding embodiments, comprising a device for spectroscopically measuring material applied to the printing surface.
17. The printing apparatus according to any one of the preceding embodiments, wherein the printing heads(s) each comprise(s) a device for measuring the flow rate of material flowing into and/or through the printing heads.
18. The printing apparatus according to one of the preceding embodiments, wherein the printing head(s) each comprise(s) a device for measuring the number of droplets emerging from the printing nozzle(s), preferably the number of emerging droplets per unit of time.
19. The printing apparatus according to any one of the preceding embodiments, comprising a device for recording a thermal image of material emerging from the printing nozzle(s) and/or of material applied to the printing surface.
20. The printing apparatus according to any one of the preceding embodiments, wherein the printing heads(s) comprise(s) an magnetic-inductive flow device.
21. The printing apparatus according to any one of the preceding embodiments, wherein the printing table comprises a weighing device.
22. A method for additive manufacturing of objects, preferably pharmaceutical dosage forms, using the apparatus according to any one of the preceding embodiments, comprising the steps of:
   (a) positioning the printing table in an x-y position in a manner such that the x-y position of an expected theoretical position of the printing nozzle corresponds to the x-y position of a reference point of the printing table and a recording of the or a printing nozzle by the optical device can be carried out at least from below;
   (b) recording of an image of the printing nozzle;
   (c) determining the actual x-y position of the printing nozzle using the captured image;
   (d) positioning the printing table in the x-y plane so that the reference point of the printing table is in the actual x-y position of the printing nozzle above the reference point;
   (e) measuring the difference between the actual x-y position of the printing nozzle above the reference point of the printing table and an expected x-y position of the printing nozzle above the reference point of the printing table;
   (f) recording, preferably storing, the difference;
   (g) recording of a further image of the printing nozzle by the optical device to check the actual x-y position of the printing nozzle above the reference point of the printing table; and
   (h) printing an object taking into account the measured or recorded difference between the actual x-y position of the printing nozzle above the reference point of the printing table and the expected x-y position of the printing nozzle above the reference point of the printing table.
23. The method according to embodiment 22, wherein in step (b) the optical device configured to record the printing nozzle(s) from the side additionally records the printing nozzle(s) from the side.
24. The method according to embodiment 23, wherein in step (c) the actual z-position of the printing nozzle above the printing table is additionally determined on the basis of the image of the printing nozzle from the side.
25. The method according to embodiment 24, wherein in step (e) the difference between the actual z-position of the printing nozzle above the printing table and an expected z-position of the printing nozzle above the printing table is additionally measured.
26. The method according to embodiment 25, wherein in step (f) the difference between the actual z-position and an expected z-position of the printing nozzle above the printing table is additionally recorded, preferably stored.
27. The method according to embodiment 26, wherein in step (g) a further image of the printing nozzle is additionally recorded by the optical device from the side for checking the actual z-position of the printing nozzle above the printing table.
28. The method according to embodiment 27, wherein in step (h) the object is printed by additionally taking into account the recorded difference of the actual z-position of the printing nozzle above the printing table from the expected z-position of the printing nozzle above the printing table.
29. The method according to embodiment 22, wherein the printing apparatus comprises a proximity sensor configured to detect the actual z-position of the printing nozzle above the printing table, and in step (c) the actual z-position of the printing nozzle above the printing table is additionally measured by the proximity sensor.
30. The method according to embodiment 29, wherein in step (e) the difference between the actual z-position of the printing nozzle above the printing table and an expected z-position of the printing nozzle above the printing table is additionally measured.
31. method according to embodiment 30, wherein in step (f) the difference between the actual z-position and the expected z-position of the printing nozzle above the printing table is additionally recorded, preferably stored.
32. The method according to embodiment 31, wherein in step (g) a further measurement of the z-position of the printing nozzle above the printing table is additionally carried out to check the actual z-position of the printing nozzle above the printing table.
33. The method according to embodiment 32, wherein in step (h) the object is printed by additionally taking into account the recorded difference of the actual z-position of the printing nozzle above the printing table from the expected z-position of the printing nozzle above the printing table.

1. Printing apparatus for additive manufacturing processes, comprising
one or more printing heads, each having a printing nozzle, wherein, optionally, the printing head or printing heads are vertically movable, and
a printing bed comprising a printing table movable in an x-axis and y-axis of a horizontal plane and optionally in a vertical direction, the printing table having a printing surface,
wherein the printing table includes an optical device configured to optically detect the printing nozzle or printing nozzles from below and record an image of the printing nozzle or printing nozzles.

2. The printing apparatus according to claim 1, wherein the optical device records the printing nozzle(s) directly from below.

3. The printing apparatus according to claim 1, wherein the optical device comprises at least one mirror configured to indirectly recording the printing nozzle(s).

4. The printing apparatus according to claim 1, wherein the optical device is further configured to record the printing nozzle or printing nozzles from the side.

5. The printing apparatus according to claim 4, wherein the optical device is configured to record the printing nozzle or printing nozzles from two sides, preferably opposite sides.

6. The printing apparatus according to claim 4, wherein the optical device comprises a mirror configured to record the printing nozzle(s) from the side.

7. The printing apparatus according to claim 5, wherein the optical device comprises two mirrors configured to record the printing nozzle(s) from two sides, preferably opposite sides.

8. The printing apparatus according to claim 6, wherein the mirror for recording the printing nozzle or nozzles from the side is/are configured in a whereby at least one recording of the printing nozzle or nozzles from the side can be generated in a partial section of the recording of the printing head or printing heads from below.

9. The printing apparatus according to claim 1, wherein the optical device is arranged in a recording device separate from the printing surface.

10. The printing apparatus according to claim 1, wherein the optical device comprises one or more CCD cameras.

11. The printing apparatus according to claim 1, comprising one or more proximity sensors, preferably one proximity sensor per printing head/printing nozzle, which is/are arranged and configured in the printing apparatus in a manner such that the respective proximity sensor detects the printing nozzle assigned thereto when the assigned printing nozzle has a respective predetermined distance from the respective proximity sensor.

12. The printing apparatus according to claim 11, wherein the proximity sensor(s) is/are selected from inductive and capacitive proximity sensors, preferably capacitive proximity sensors.

13. The printing apparatus according to claim 1, comprising a computerized control device configured to move and detect the position of the printing table and/or at least the printing nozzle(s) of the printing head(s).

14. The printing apparatus according to any claim 1, comprising a computerized image processing device configured to display and process the image data of the printing nozzle(s) generated by the optical device.

15. The printing apparatus according to claim 1, wherein printing apparatus comprises a computer unit configured to correlate image data from a computerized image processing device configured to display and process the image data of the printing nozzle(s) generated by the optical device and position data from a computerized control device configured to move and detect the position of the printing table and/or at least the printing nozzle(s) of the printing head(s).

16.-21. (canceled)

22. A method for additive manufacturing of objects, preferably pharmaceutical dosage forms, using a printing apparatus comprising
one or more printing heads, each having a printing nozzle, and
a printing bed comprising a printing table movable in an x-axis and y-axis of a horizontal plane, the printing table having a printing surface, wherein the printing table includes an optical device configured to optically detect the printing nozzle or printing nozzles from below and record an image of the printing nozzle or printing nozzles;
the method, comprising the steps of:
(a) positioning the printing table in an x-y position in a manner such that the x-y position of an expected theoretical position of the printing nozzle corresponds to the x-y position of a reference point of the printing table whereby the optical device can optically detect and record an image of the printing nozzle from below;
(b) optically detecting and recording of an image of the printing nozzle;
(c) determining the actual x-y position of the printing nozzle using the captured image;
(d) positioning the printing table in the x-y plane so that the reference point of the printing table is in the actual x-y position of the printing nozzle above the reference point;
(e) measuring the difference between the actual x-y position of the printing nozzle above the reference point of the printing table and an expected x-y position of the printing nozzle above the reference point of the printing table;
(f) recording, preferably storing, the difference;
(g) recording of a further image of the printing nozzle by the optical device to check the actual x-y position of the printing nozzle above the reference point of the printing table; and
(h) printing an object taking into account the measured or recorded difference between the actual x-y position of the printing nozzle above the reference point of the printing table and the expected x-y position of the printing nozzle above the reference point of the printing table.

23. The method according to claim 22, wherein in step (b) the optical device configured to record the printing nozzle(s) from the side additionally records the printing nozzle(s) from the side.

24. The method according to claim 23, wherein in step (c) an actual z-position of the printing nozzle above the printing table is additionally determined on the basis of the image of the printing nozzle from the side.

25. The method according to claim 24, wherein in step (e) the difference between the actual z-position of the printing nozzle above the printing table and an expected z-position of the printing nozzle above the printing table is additionally measured.

26. The method according to claim 25, wherein in step (f) the difference between the actual z-position and an expected z-position of the printing nozzle above the printing table is recorded, preferably stored.

27. The method according to claim 26, wherein in step (g) a further image of the printing nozzle is recorded by the optical device from the side for checking the actual z-position of the printing nozzle above the printing table.

28. The method according to claim 27, wherein in step (h) the object is printed by additionally taking into account the recorded difference of the actual z-position of the printing nozzle above the printing table from the expected z-position of the printing nozzle above the printing table.

29. The method according to claim 22, wherein the printing apparatus comprises a proximity sensor configured to detect the actual z-position of the printing nozzle above the printing table, and in step (c) the actual z-position of the printing nozzle above the printing table is additionally measured by the proximity sensor.

30. The method according to claim 29, wherein in step (e) the difference between the actual z-position of the printing nozzle above the printing table and an expected z-position of the printing nozzle above the printing table is additionally measured.

31. The method according to claim 30, wherein in step (f) the difference between the actual z-position and the expected z-position of the printing nozzle above the printing table is additionally recorded, preferably stored.

32. The method according to claim 31, wherein in step (g) a further measurement of the z-position of the printing nozzle above the printing table is additionally carried out to check the actual z-position of the printing nozzle above the printing table.

33. The method according to claim 32, wherein in step (h) the object is printed by additionally taking into account the recorded difference of the actual z-position of the printing nozzle above the printing table from the expected z-position of the printing nozzle above the printing table.
